(19) United States
(12) Patent Application Publication
(10) Pub. No.: US 2024/0146400 A1
(43) Pub. Date: May 2, 2024

(54) SERVER, CONTROL METHOD, AND COMPUTER-READABLE NON-TRANSITORY RECORDING MEDIUM

(71) Applicant: NEC Corporation, Tokyo (JP)

(72) Inventors: Kazuyuki HAYASHI, Tokyo (JP); Masakazu Ono, Tokyo (JP); Junichi Funada, Tokyo (JP); Kenji Wakafuji, Tokyo (JP); Kohei Yoshida, Tokyo (JP)

(73) Assignee: NEC Corporation, Tokyo (JP)

(21) Appl. No.: 18/381,845

(22) Filed: Oct. 19, 2023

(30) Foreign Application Priority Data
Oct. 28, 2022 (JP) 2022-173808

(51) Int. Cl. H04B 7/185; B64G 1/10; B64G 1/24; H04W 24/08; H04W 64/00

(52) U.S. Cl. CPC H04B 7/18513; B64G 1/1007; B64G 1/24; H04B 7/18502; H04B 7/18519; H04W 24/08; H04W 64/00

(57) ABSTRACT

At least one processor included in a server carries out: an acquiring process of acquiring, from a communication terminal configured to communicate with low earth orbit satellite equipment, information which indicates a communication condition in the communication terminal regarding communication with the low earth orbit satellite equipment; and a controlling process of referring to a radio wave map of a region including a location of the communication terminal and the information, to control an air vehicle configured to measure an attenuation of a radio wave between the air vehicle and the communication terminal.

### CROSS REFERENCE TO RELATED APPLICATIONS

This application is based upon and claims the benefit of priority from Japanese Patent Application No. 2022-173808 filed on Oct. 28, 2022, the disclosure of which is incorporated herein in its entirety by reference.

### TECHNICAL FIELD

The present invention relates to a server, a control method, and a computer-readable non-transitory recording medium which control an air vehicle.

### BACKGROUND ART

A technique of acquiring, from equipment on earth, data measured on earth, using the data to generate data to be used by equipment on earth, and transmitting the data to equipment on earth has been disclosed.

Patent Literature 1 discloses a satellite constellation system which includes satellite equipment that derives a signal from measurement values or the like received from a monitoring station on earth, and transmits the signal to a client device. In the satellite constellation system, the signal transmitted from the satellite equipment causes the client device to calculate at least one selected from the group consisting of an accurate position and an accurate time.

### CITATION LIST

### Patent Literature

[Patent Literature 1]
Japanese Translation of PCT International Application, Tokuhyo, No. 2022-534387

### SUMMARY OF INVENTION

### Technical Problem

In communications between equipment on earth and satellite equipment, the communication environment changes due to the influence of rainfall or the like in some cases. When the environment of communication between equipment on earth and satellite equipment worsens, the communication between the equipment on earth and the satellite equipment could be interrupted. Since Patent Literature 1 does not consider such a case, there is a problem of the equipment on earth being incapable of maintaining the communication in a case where the environment of communication between the equipment on earth and the satellite equipment worsens.

An example aspect of the present invention has been made in view of the above problem, and an example object thereof is to provide a technique of equipment on earth suitably maintaining communication.

### Solution to Problem

A server in accordance with an example aspect of the present invention includes at least one processor, and the at least one processor carries out: an acquiring process of acquiring, from a communication terminal configured to communicate with low earth orbit satellite equipment, information which indicates a communication condition in the communication terminal regarding communication with the low earth orbit satellite equipment; and a controlling process of referring to a radio wave map of a region including a location of the communication terminal and the information, to control an air vehicle configured to measure an attenuation of a radio wave between the air vehicle and the communication terminal.

A control method in accordance with an example aspect of the present invention includes: at least one processor included in a server acquiring, from a communication terminal configured to communicate with low earth orbit satellite equipment, information which indicates a communication condition in the communication terminal regarding communication with the low earth orbit satellite equipment; and the at least one processor referring to a radio wave map of a region including a location of the communication terminal and the information, to control an air vehicle configured to measure an attenuation of a radio wave between the air vehicle and the communication terminal.

A computer-readable non-transitory recording medium in accordance with an example aspect of the present invention has recorded thereon a program for causing a computer to function as a server, and the program causes the computer to carry out: an acquiring process of acquiring, from a communication terminal configured to communicate with low earth orbit satellite equipment, information which indicates a communication condition in the communication terminal regarding communication with the low earth orbit satellite equipment; and a controlling process of referring to a radio wave map of a region including a location of the communication terminal and the information, to control an air vehicle configured to measure an attenuation of a radio wave between the air vehicle and the communication terminal.

### Advantageous Effects of Invention

With an example aspect of the present invention, it is possible for equipment on earth to suitably maintain communication.

### BRIEF DESCRIPTION OF DRAWINGS

FIG. 1 is a block diagram illustrating a configuration of a server in accordance with a first example embodiment of the present invention.

FIG. 2 is a flowchart illustrating a flow of a control method in accordance with the first example embodiment of the present invention.

FIG. 3 is a block diagram illustrating a configuration of a communication system in accordance with a second example embodiment of the present invention.

FIG. 4 is a diagram illustrating an example process in the communication system in accordance with the second example embodiment of the present invention.

FIG. 5 is a diagram illustrating another example process in the communication system in accordance with the second example embodiment of the present invention.

FIG. 6 is a diagram illustrating still another example process in the communication system in accordance with the second example embodiment of the present invention.

FIG. 7 is a block diagram illustrating an example hardware configuration of the server, a communication terminal, an air vehicle, and an LEO satellite of the example embodiments of the present invention.

### EXAMPLE EMBODIMENTS

### First Example Embodiment

The following description will discuss a first example embodiment of the present invention in detail, with reference to the drawings. The present example embodiment is basic to an example embodiment which will be described later.

(Outline of Server 1)

A server 1 in accordance with the present example embodiment is capable of transmitting data to and receiving data from a communication terminal that communicates with low earth orbit satellite equipment. The server 1 is also capable of transmitting data to and receiving data from an air vehicle which measures an attenuation of a radio wave between the air vehicle and the communication terminal.

The server 1 refers to (i) information indicating a communication condition in the communication terminal regarding communication with the low earth orbit satellite equipment and (ii) a radio wave map of a region including the location of the communication terminal, to control the air vehicle, which measures an attenuation of a radio wave between the air vehicle and the communication terminal. The radio wave map is a map in which a place and a radio wave condition at the place are graphically represented with the place being associated with the radio wave map. Examples of the radio wave map encompass a radio wave map representing a condition in which the communication terminal is capable of normally conducting communication (stable condition), a radio wave map representing a condition in which the communication terminal is incapable of conducting communication (a condition in which a communication anomaly occurs), and a radio wave map representing the status of use, by the communication terminal, of a radio wave. Further, each of the radio wave maps may be a radio wave map in a two-dimensional space, or may be a radio wave map in a three-dimensional space. In addition, the radio wave condition in each of the radio wave maps may be a radio wave condition based on information acquired in real time, or may be a radio wave condition based on previously-acquired information.

(Configuration of Server 1)

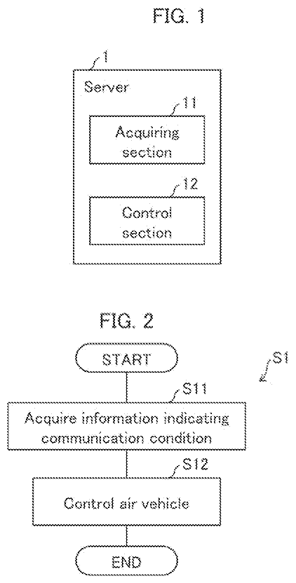

A configuration of the server 1 in accordance with the present example embodiment will be described with reference to FIG. 1. FIG. 1 is a block diagram illustrating a configuration of the server 1 in accordance with the present example embodiment.

As illustrated in FIG. 1, the server 1 includes an acquiring section 11 and a control section 12. The acquiring section 11 and the control section 12 are components for implementing, in the present example embodiment, the acquiring means and the control means, respectively.

The acquiring section 11 acquires, from the communication terminal that communicates with the low earth orbit satellite equipment, information indicating the communication condition in the communication terminal regarding communication with the low earth orbit satellite equipment. The acquiring section 11 supplies the acquired information to the control section 12.

The control section 12 refers to the information acquired by the acquiring section 11 and the radio wave map of a region including the location of the communication terminal, to control an air vehicle which measures an attenuation of a radio wave between the air vehicle and the communication terminal.

As above, the configuration employed in the server 1 in accordance with the present example embodiment is a configuration including: the acquiring section 11, which acquires, from a communication terminal which communicates with low earth orbit satellite equipment, information indicating a communication condition in the communication terminal regarding communication with the low earth orbit satellite equipment; and the control section 12, which refers to the information acquired by the acquiring section 11 and the radio wave map of a region including the location of the communication terminal, to control an air vehicle that measures an attenuation of a radio wave between the air vehicle and the communication terminal.

Thus, in a case where the communication condition at the location of the communication terminal is poor compared with that represented by the radio wave map due to, for example, the influence of rainfall, the server 1 in accordance with the present example embodiment can control the air vehicle so that the air vehicle measures an attenuation of a radio wave in the region in which the communication terminal is located. Therefore, with the server 1 in accordance with the present example embodiment, it is possible to understand the worsening of the communication environment of equipment on earth and take a measure to maintain the communication of the equipment on earth. This provides an example advantage of enabling the equipment on earth to suitably maintain communication.

(Flow of Control Method S1)

A flow of a control method S1 in accordance with the present example embodiment will be described with reference to FIG. 2. FIG. 2 is a flowchart illustrating a flow of the control method S1 in accordance with the present example embodiment.

(Step S11)

In step S11, the acquiring section 11 acquires, from the communication terminal that communicates with the low earth orbit satellite equipment, information indicating a communication condition in the communication terminal regarding communication with the low earth orbit satellite equipment. The acquiring section 11 supplies the acquired information to the control section 12.

(Step S12)

In step S12, the control section 12 refers to the information acquired by the acquiring section 11 and the radio wave map of a region including the location of the communication terminal, to control the air vehicle that measures an attenuation of a radio wave between the air vehicle and the communication terminal.

As above, the configuration employed in the control method S1 in accordance with the present example embodiment is such that: in step S11, the acquiring section 11 acquires, from a communication terminal which communicates with low earth orbit satellite equipment, information indicating a communication condition in the communication terminal regarding communication with the low earth orbit satellite equipment; and in step S12, the control section 12 refers to the information acquired by the acquiring section 11 and the radio wave map of a region including the location of the communication terminal, to control the air vehicle that measures an attenuation of a radio wave between the air vehicle and the communication terminal. Thus, the control method S1 in accordance with the present example embodiment provides the same example advantage provided by the server 1 described above.

### Second Example Embodiment

The following description will discuss a second example embodiment of the present invention in detail, with reference to the drawings. A component that has the same function as a component described in the first example embodiment is assigned the same reference sign, and the description thereof is omitted where appropriate.

(Outline of Communication System 100)

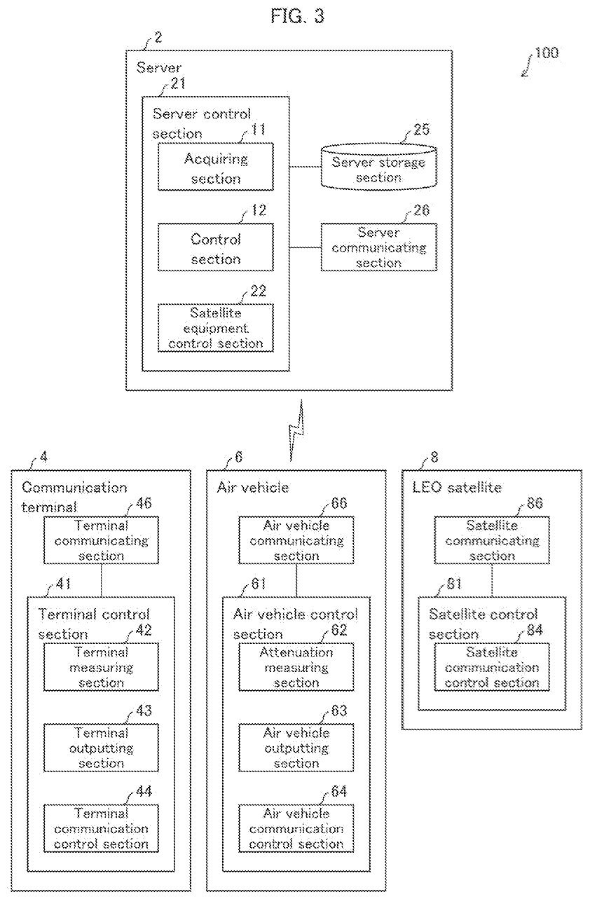

FIG. 3 is a block diagram illustrating a configuration of a communication system 100 in accordance with the present example embodiment. As illustrated in FIG. 3, the communication system 100 includes a server 2, a communication terminal 4, an air vehicle 6, and a low earth orbit (LEO) satellite 8 (low earth orbit satellite equipment). Each of the server 2, the communication terminal 4, the air vehicle 6, and the LEO satellite 8 is capable of transmitting and receiving data via wireless communication. Although the communication system 100 illustrated in FIG. 3 has a single communication terminal 4, a single air vehicle 6, and a single LEO satellite 8, a plurality of communication terminals 4, a plurality of air vehicles 6, and a plurality of LEO satellites 8 may be included.

In the communication system 100, the server 2 acquires a radio wave map representing the status of use of a radio wave in a region including the location of the communication terminal 4. Examples of a method of the server 2 acquiring the radio wave map encompass a method of acquiring a radio wave map from radio wave map measuring equipment (not illustrated in FIG. 3), and a method of the server 2 generating a radio wave map on the basis of the values of received power acquired from respective communication terminals 4. In addition, because a radio wave map varies from moment to moment, the server 2 may acquire a real-time radio wave map.

The server 2 refers to (i) information indicating a communication condition in the communication terminal 4 regarding communication with the LEO satellite 8 and (ii) a radio wave map of a region including the location of the communication terminal 4, to control the air vehicle that measures an attenuation of a radio wave between the air vehicle and the communication terminal 4. In this process, the radio wave map referred to by the server 2 is a map representing a radio wave that allows the communication terminal 4 to normally conduct communication, which is, in other words, a radio wave map representing a stable condition. Further, in this process, the radio wave map referred to by the server 2 may be a radio wave map in a three-dimensional space.

As an example, the server 2 compares the intensity of a radio wave indicated by information that indicates a communication condition in the communication terminal 4 regarding communication with the LEO satellite 8, with the intensity of a radio wave of a region including the location of the communication terminal 4 in the radio wave map. In a case where the server 2 determines, on the basis of the result of the comparison, that the communication condition worsens in the region including the location of the communication terminal 4, the server 2 causes the air vehicle 6 to move to be located above the region including the location of the communication terminal 4, and controls the air vehicle 6 so that the air vehicle 6 measures an attenuation of a radio wave between the air vehicle 6 and the communication terminal 4.

The server 2 may further control the LEO satellite 8. As an example, the server 2 controls the LEO satellite 8 so that the LEO satellite 8 changes either the intensity of a radio wave or the emission direction of the radio wave.

In the communication system 100, the communication terminal 4 is a communication terminal used by a user. Examples of the communication terminal 4 encompass a mobile terminal and a smartphone.

In the communication system 100, the air vehicle 6, for example, moves under the direction of the server 2, and measures an attenuation of a radio wave between the air vehicle 6 and the communication terminal 4, at the position at which the air vehicle 6 is flying under the direction of the server 2. The air vehicle 6 outputs, to the server 2, an attenuation measured. Examples of the air vehicle 6 encompass an unmanned aerial vehicle (UAV, drone) and a high altitude platform station (HAPS).

As an example of a method of the air vehicle 6 measuring an attenuation, the air vehicle 6 communicates with the communication terminal 4 to acquire, from the communication terminal 4, information indicating received power. The air vehicle 6 then calculates an attenuation on the basis of (i) the difference between the transmission power and the received power indicated by the information acquired from the communication terminal 4 and (ii) the distance between the air vehicle 6 and the communication terminal 4. As another example of the method of the air vehicle 6 measuring an attenuation, the air vehicle 6 communicates with the LEO satellite 8 to acquire, from the LEO satellite 8, information indicating transmission power. The air vehicle 6 then calculates an attenuation on the basis of (i) the difference between the transmission power indicated by the information acquired and the received power of the air vehicle 6 and (ii) the distance between the air vehicle 6 and the LEO satellite 8.

The LEO satellite 8 is low earth orbit satellite equipment which follows a predetermined orbit. The information that indicates the predetermined orbit followed by the LEO satellite 8 is referred to as orbit information. In addition, the LEO satellite 8 is capable of changing the emission intensity and emission direction of a radio wave used by the communication terminal 4 for wireless communication.

(Configuration of Server 2)

As illustrated in FIG. 3, the server 2 includes a server control section 21, a server storage section 25, and a server communicating section 26.

The server storage section 25 is storage in which data is stored. The server storage section 25 has stored therein data to be referred to by the server control section 21. Examples of the data stored in the server storage section 25 encompass a radio wave map, a policy (the details of which will be described later) determined regarding the control of each equipment included in the communication system 100, information indicating a radio wave condition transmitted by the communication terminal 4, and the orbit information regarding the LEO satellite 8.

The server communicating section 26 communicates with another equipment via wireless communication. As an example, the server communicating section 26 receives a radio wave map, information indicating a communication condition in the communication terminal 4 regarding communication with the LEO satellite 8, and an attenuation measured by the air vehicle 6, and transmits control information for controlling another equipment.

(Functions of Server Control Section 21)

The server control section 21 controls each component included in the server 2. As illustrated in FIG. 3, the server control section 21 includes an acquiring section 11, a control section 12, and a satellite equipment control section 22. In the present example embodiment, the acquiring section 11 is a component for implementing the acquiring means, and the control section 12 and the satellite equipment control section 22 are components for implementing the control means.

The acquiring section 11 acquires data via the server communicating section 26. As an example, the acquiring section 11 acquires, from the communication terminal 4 that communicates with the LEO satellite 8, information indicating a communication condition in the communication terminal 4 regarding communication with the LEO satellite 8.

The control section 12 refers to the policy stored in the server storage section 25 to control the air vehicle 6. As an example, the policy contains information regarding at least any one selected from the group consisting of equipment which communicates with the communication terminal 4, equipment which measures a radio wave condition, a place to which the air vehicle 6 moves, the emission intensity of a radio wave of the LEO satellite 8, and the emission direction of the radio wave of the LEO satellite 8.

As an example, the control section 12 refers to the information acquired by the acquiring section 11 and the radio wave map of the region including the location of the communication terminal 4, to control the air vehicle 6 that measures an attenuation of a radio wave between the air vehicle 6 and the communication terminal 4. A process carried out by the control section 12 will be described in the example processes (which will be described later) in the communication system 100.

The satellite equipment control section 22 controls the LEO satellite 8. As an example, the satellite equipment control section 22 controls the LEO satellite 8 so that the LEO satellite 8 increases the intensity of a radio wave to be emitted or changes the emission direction of the radio wave.

The communication system 100 may have a single server 2 as illustrated in FIG. 3, or may be formed by a plurality of servers each of which has the functions of the server 2 illustrated in FIG. 3.

(Configuration of Communication Terminal 4)

As illustrated in FIG. 3, the communication terminal 4 includes a terminal control section 41 and a terminal communicating section 46.

The terminal communicating section 46 communicates with another equipment via wireless communication. As an example, the terminal communicating section 46 transmits received power in the communication terminal 4 to the server 2.

(Functions of Terminal Control Section 41)

The terminal control section 41 controls each component included in the communication terminal 4. As illustrated in FIG. 3, the terminal control section 41 includes a terminal measuring section 42, a terminal outputting section 43, and a terminal communication control section 44.

The terminal measuring section 42 measures the intensity of a radio wave. As an example, the terminal measuring section 42 measures received power in data reception carried out via the terminal communicating section 46. The terminal measuring section 42 supplies, to the terminal outputting section 43, the received power measured.

The terminal outputting section 43 outputs data to the server 2 or the air vehicle 6 via the terminal communicating section 46. As an example, the terminal outputting section 43 outputs, to the server 2 or the air vehicle 6 via the terminal communicating section 46, received power as information indicating the intensity of the radio wave, the received power being measured by the terminal measuring section 42.

The terminal communication control section 44 controls communication conducted by the communication terminal 4. As an example, the terminal communication control section 44 changes the other end of communication from the air vehicle 6 to the LEO satellite 8 on the basis of control information outputted by the server 2.

(Configuration of Air Vehicle 6)

As illustrated in FIG. 3, the air vehicle 6 includes an air vehicle control section 61 and an air vehicle communicating section 66.

The air vehicle communicating section 66 communicates with another equipment via wireless communication. As an example, the air vehicle communicating section 66, for example, transmits a measured attenuation to the server 2 and receives, from the server 2, information for controlling the air vehicle 6.

(Functions of Air Vehicle Control Section 61)

The air vehicle control section 61 controls each component included in the air vehicle 6. As illustrated in FIG. 3, the air vehicle control section 61 includes an attenuation measuring section 62, an air vehicle outputting section 63, an air vehicle communication control section 64.

The attenuation measuring section 62 measures the attenuation of a radio wave. As an example, the attenuation measuring section 62 measures the attenuation of a radio wave between the air vehicle 6 and the communication terminal 4. A method of the attenuation measuring section 62 measuring an attenuation is as described above. The attenuation measuring section 62 supplies, to the air vehicle outputting section 63, an attenuation measured.

The air vehicle outputting section 63 acquires data via the air vehicle communicating section 66. As an example, the air vehicle outputting section 63 outputs an attenuation measured by the attenuation measuring section 62, to the server 2 via the air vehicle communicating section 66.

The air vehicle communication control section 64 controls communication conducted by the air vehicle 6. As an example, the air vehicle communication control section 64 communicates with the communication terminal 4 on the basis of control information outputted by the server 2.

(Configuration of LEO Satellite 8)

As illustrated in FIG. 3, the LEO satellite 8 includes a satellite control section 81 and a satellite communicating section 86.

The satellite control section 81 controls each component included in the LEO satellite. As illustrated in FIG. 3, the satellite control section 81 includes a satellite communication control section 84.

The satellite communication control section 84 controls communication conducted by the LEO satellite 8. As an example, the satellite communication control section 84 communicates with the communication terminal 4 on the basis of control information outputted by the server 2. As another example, the satellite communication control section 84 changes the intensity of a radio wave to be emitted and the emission direction of the radio wave, on the basis of the control information on outputted by the server 2.

The satellite communicating section 86 communicates with another equipment via wireless communication. As an example, the satellite communicating section 86 receives, from the server 2, information for controlling the LEO satellite 8.

### Example Process 1 in Communication System 100

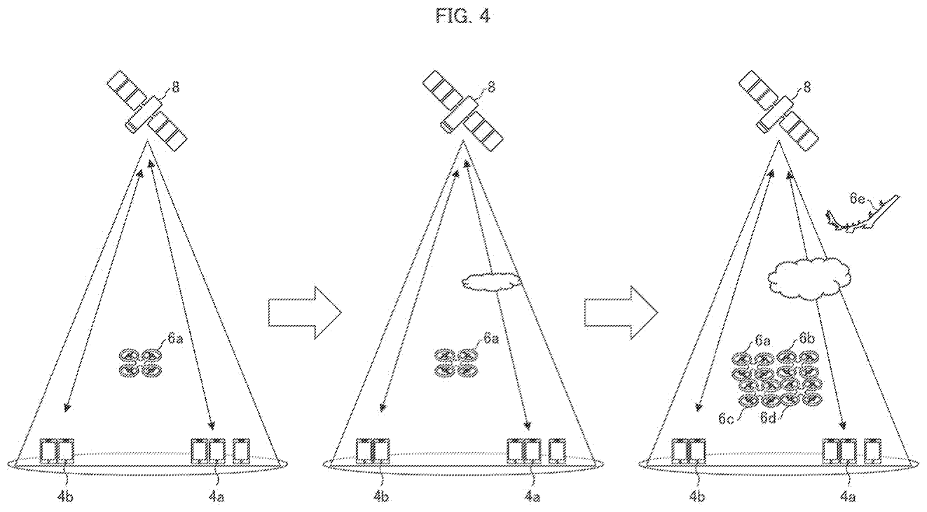

FIG. 4 is a diagram illustrating an example process in the communication system 100 in accordance with the present example embodiment.

In the communication system 100 Illustrated in FIG. 4, the LEO satellite 8, a communication terminal 4a, and a communication terminal 4b are in communication with each other, as illustrated on the left side of FIG. 4. In the state illustrated on the left side of FIG. 4, the acquiring section 11 of the server 2 acquires information indicating the condition of communication with the LEO satellite 8, from each of the communication terminal 4a and the communication terminal 4b. As an example, the acquiring section 11 acquires information indicating the intensity of a radio wave as information indicating a communication condition. In the diagram illustrated on the left side of FIG. 4, an air vehicle 6a has not received instructions from the server 2 yet, and is waiting for the instructions.

Next, as illustrated in the middle of FIG. 4, when a cloud is formed between the LEO satellite 8 and the communication terminal 4a, the value which represents the intensity, indicated in the communication terminal 4a, of a radio wave from the LEO satellite 8 and which is indicated by the information acquired by the server 2 from the communication terminal 4a is lower than the value representing the intensity, indicated in the radio wave map, of a radio wave at the location of the communication terminal 4a.

In a case where, at the location of the communication terminal 4a, the intensity of a radio wave indicated by the information acquired from the communication terminal 4a is smaller than a predetermined value based on the intensity of a radio wave indicated by the radio wave map, the control section 12 of the server 2 controls the air vehicle 6a. As an example, the control section 12 controls the air vehicle 6a so that the air vehicle 6a measures an attenuation at the location of the communication terminal 4a. More specifically, the control section 12 transmits, to the air vehicle 6a via the server communicating section 26, control information for controlling the air vehicle 6a so that the air vehicle 6a measures an attenuation of a radio wave between the air vehicle 6a and the communication terminal 4a at the location of the communication terminal 4a.

The predetermined value is not particularly limited, but examples thereof encompass a case where the intensity of a radio wave indicated by the information acquired from the communication terminal 4a is smaller than the intensity of a radio wave indicated by the radio wave map, and a case where the intensity of a radio wave indicated by the information acquired from the communication terminal 4a is less than 80% of the intensity of a radio wave represented by the radio wave map. Thus, in a case where, at the location of the communication terminal 4a, the intensity of a radio wave indicated by the information acquired from the communication terminal 4a decreases to a degree which is considered to result in worsening of the quality of communication between the communication terminal 4a and the LEO satellite 8 (e.g., an increase in the error rate of data transmission and reception in a state of establishment of communication between the communication terminal 4a and the LEO satellite 8), the control section 12 may control the air vehicle 6a so that the air vehicle 6a measures, at the location of the communication terminal 4a, an attenuation of a radio wave between the air vehicle 6a and the communication terminal 4a.

In addition, the control section 12 may have the function of predicting, on the basis of the intensity of a radio wave indicated by a radio wave map and a log of intensities of radio waves indicated by the information acquired by the communication terminal 4a, whether a radio wave condition abruptly changes at the location of the communication terminal 4a within a predetermined period of time (e.g., 1 minute, 10 minutes, or 1 hour). Examples of such a configuration encompass using a trained model which has learned to output, for input information which contains the intensity of a radio wave indicated by the radio wave map and the log of intensities of radio waves indicated by the information acquired from the communication terminal 4a, the result of prediction of a radio wave condition at the location of the communication terminal 4a after the elapse of a predetermined period of time. In a case where the result outputted by the trained model indicates worsening of a radio wave condition at the location of the communication terminal 4a after the elapse of a predetermined period of time, the control section 12 may control the air vehicle 6a so that the air vehicle 6a measures an attenuation at the location of the communication terminal 4a.

When acquiring, from the server 2, control information for controlling the air vehicle 6a so that the air vehicle 6a measures an attenuation at the location of the communication terminal 4a, the attenuation measuring section 62 of the air vehicle 6a moves on the basis of the control information to be located above a region in which the communication terminal 4a is located, as illustrated on the right side of FIG. 4. The attenuation measuring section 62 then measures an attenuation of a radio wave between the air vehicle 6a and the communication terminal 4a, at the location of the communication terminal 4a.

As illustrated in the right side of FIG. 4, the control section 12 of the server 2 may transmit, to not only other air vehicles 6b to 6d but also an air vehicle 6e, in addition to the air vehicle 6a, control information for controlling these air vehicles so that these air vehicles measure an attenuation at the location of the communication terminal 4a.

A method of the control section 12 determining to which air vehicle 6 of the plurality of air vehicles 6 to transmit control information is not particularly limited. As an example, the control section 12 acquires, from each of the plurality of air vehicles 6, position information indicating a position at which that air vehicle 6 is flying, at predetermined time intervals (e.g., 1 minute, 10 minutes). The control section 12 then may refer to the position information to transmit, to the air vehicle 6 that is located near the region in which the communication terminal 4a is located, control information for controlling the air vehicle 6 so that the air vehicle 6 measures an attenuation at the location of the communication terminal 4a.

As another example, the control section 12 may transmit, to the air vehicle 6 other than the air vehicle 6 that is measuring an attenuation in another region, control information for controlling the air vehicle 6 so that the air vehicle 6 measures an attenuation at the location of the communication terminal 4a.

By selecting the air vehicle 6 to be controlled from among the plurality of air vehicles 6, it is possible for the control section 12 to efficiently operate the plurality of air vehicles 6.

As above, in the communication system 100 in accordance with the present example embodiment, in a case where the condition of communication between the communication terminal 4a and the LEO satellite 8 worsens, the server 2 controls the air vehicle 6a so that the air vehicle 6a measures an attenuation at the location of the communication terminal 4a. It is therefore possible for the server 2 to understand that the communication environment of the communication terminal 4a worsens and take a measure to maintain the communication of the communication terminal 4a. This makes it possible for the communication terminal 4a to suitably maintain communication.

### Example Process 2 in Communication System 100

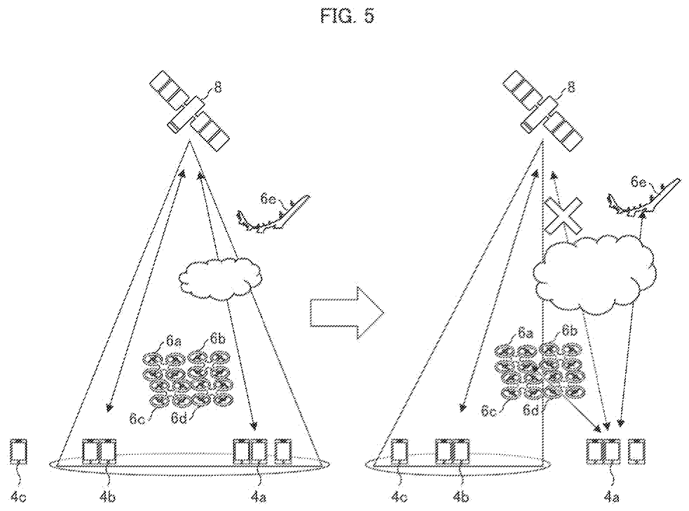

FIG. 5 is a diagram illustrating another example process in the communication system 100 in accordance with the present example embodiment. In the following description, a process carried out by the air vehicle 6a may be carried out by any of the air vehicles 6b to 6e, which are the other air vehicles, instead of the air vehicle 6a. Also in a case where a process carried out by the air vehicle 6a is carried out by any of the air vehicles 6b to 6e in the following description, the same example advantage is obtained.

When acquiring, from the server 2, control information for controlling the air vehicle 6a so that the air vehicle 6a measures an attenuation at the location of the communication terminal 4a, the air vehicle 6a moves on the basis of the control information to be located above a region in which the communication terminal 4a is located, as illustrated on the left side of FIG. 5. The attenuation measuring section 62 of the air vehicle 6a then measures an attenuation of a radio wave between the air vehicle 6a and the communication terminal 4a, at the location of the communication terminal 4a.

When measuring an attenuation of a radio wave between the air vehicle 6a and the communication terminal 4, the attenuation measuring section 62 of the air vehicle 6a transmits the measured attenuation to the server 2 via the air vehicle communicating section 66. The acquiring section 11 of the server 2 receives, via the server communicating section 26, the attenuation transmitted from the air vehicle 6a. The acquiring section 11 supplies the acquired attenuation to the control section 12. Note that, in addition to the air vehicle 6a, the air vehicles 6b to 6e may transmit the measured attenuations to the server 2 as well.

In a case where the attenuation transmitted from the air vehicle 6a is greater than a predetermined value, the control section 12 controls the air vehicle 6a so that the air vehicle 6a communicates with the communication terminal 4a. More specifically, the control section 12 transmits, to the air vehicle 6a via the server communicating section 26, control information for controlling the air vehicle 6a so that the air vehicle 6a communicates with the communication terminal 4a. Similarly, the control section 12 transmits, to the communication terminal 4a, control information for controlling the communication terminal 4a so that the communication terminal 4a communicates with the air vehicle 6a.

The predetermined value of an attenuation is not particularly limited as well, but in a case where, at the location of the communication terminal 4a, a radio wave attenuates to a degree which is considered to result in worsening of the quality of communication between the communication terminal 4a and the LEO satellite 8 (e.g., an increase in the error rate of data transmission and reception in a state of establishment of communication between the communication terminal 4a and the LEO satellite 8), the control section 12 may control the air vehicle 6a so that the air vehicle 6a communicates with the communication terminal 4a.

Further, a method of the control section 12 determining to which air vehicle 6 of the plurality of air vehicles 6 to transmit control information for controlling the air vehicle 6 so that the air vehicle 6 communicates with the communication terminal 4a is not particularly limited. As an example, the control section 12 may transmit, to the air vehicle 6 that is not in communication with any of a plurality of communication terminals 4, control information for controlling the air vehicle 6 so that the air vehicle 6 communicates with the communication terminal 4a. As another example, the control section 12 may transmit, to the air vehicle 6 the distance of which to the communication terminal 4a is the closest, control information for controlling the air vehicle 6 so that the air vehicle 6 communicates with the communication terminal 4a.

In a case where an attenuation transmitted from the air vehicle 6a is greater than a predetermined value, the control section 12 may control the LEO satellite 8 so that the LEO satellite 8 changes the emission direction of a radio wave. As an example, on the left side of FIG. 5, the control section 12 transmits, to the LEO satellite 8, control information for controlling the LEO satellite 8 so that, while maintaining communication with the communication terminal 4b, the LEO satellite 8 changes the emission direction of a radio wave, to make possible communication with a communication terminal 4c which is not located in a region in which communication with the LEO satellite 8 is possible. When obtaining the control information from the server 2, the satellite communication control section 84 of the LEO satellite 8 changes the emission direction of a radio wave, to make possible communication with the communication terminal 4c, while maintaining communication with the communication terminal 4b, as illustrated in the right side of FIG. 5.

As above, in the communication system 100 of the present example embodiment, in a case where the condition of communication between the communication terminal 4a and the LEO satellite 8 worsens and the intensity of a radio wave attenuates, the server 2 controls the other end of communication of the communication terminal 4a so that the other end of communication is changed from the LEO satellite 8, the distance of which to the communication terminal 4a is farther, to the air vehicle 6, the distance of which to the communication terminal 4a is closer. Thus, in a case where the environment of communication between the communication terminal 4a and the LEO satellite 8 worsens, the server 2 is capable of suitably maintaining communication carried out by the communication terminal 4a, by changing the destination to which the communication terminal 4a is connected.

In the communication system 100 in accordance with the present example embodiment, in a case where the condition of communication between the communication terminal 4a and the LEO satellite 8 worsens and the intensity of a radio wave attenuates, the server 2 controls the LEO satellite 8 so that the LEO satellite 8 changes the emission direction. This enables the server 2 to maintain suitable communication between the LEO satellite 8 and the communication terminal 4b and efficient operation of the LEO satellite 8 (e.g., reduction in power and the amount of processing, and maintenance of the area in which communication is possible, the maintenance being provided through communication with the communication terminal 4c, the communication with which had been impossible).

### Example Process 3 in Communication System 100

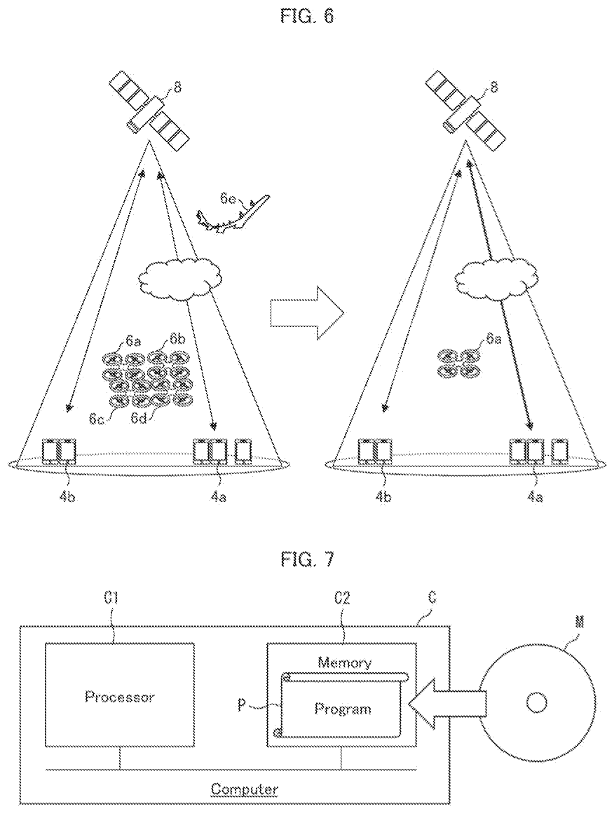

FIG. 6 is a diagram illustrating still another example process in the communication system 100 in accordance with the present example embodiment.

In a case where the attenuation transmitted from the air vehicle 6a is greater than a predetermined value, the control section 12 may control the LEO satellite 8 so that the LEO satellite 8 increases the intensity of a radio wave to be emitted. More specifically, as illustrated on the left side of FIG. 6, in a case where the communication environment of the communication terminal 4a worsens due to a cloud, the control section 12 transmits, to the LEO satellite 8 via the server communicating section 26, control information for controlling the LEO satellite 8 so that the LEO satellite 8 increases the intensity of a radio wave to be emitted.

When obtaining, via the satellite communicating section 86, the control information for controlling the LEO satellite 8 so that the LEO satellite 8 increases the intensity of a radio wave to be emitted, the satellite communication control section 84 of the LEO satellite 8 increases, on the basis of the control information, the intensity of a radio wave to be emitted, as illustrated by the arrow in bold on the right side of FIG. 6.

Further, in addition to transmission, to the LEO satellite 8, of the control information for controlling the LEO satellite 8 so that the LEO satellite 8 increases the intensity of a radio wave to be emitted, the control section 12 of the server 2 may transmit, to each of the air vehicles 6a to 6e, control information for controlling that air vehicle 6 so that the air vehicle 6 waits, or moves to another place.

A method of the control section 12 determining whether to transmit the control information for controlling the LEO satellite 8 so that the LEO satellite 8 increases the intensity of a radio wave to be emitted, or control the air vehicle 6 so that the air vehicle 6 communicates with the communication terminal 4 (and furthermore, control the LEO satellite 8 so that the LEO satellite 8 changes the emission direction of a radio wave) as described in the above Example process 2 is not particularly limited.

As an example, in a case where an attenuation is significant enough that communication between the communication terminal 4a and the LEO satellite 8 cannot be maintained even when the LEO satellite 8 emits a radio wave having the maximum intensity that the LEO satellite 8 is able to emit, the control section 12 transmits, to the air vehicle 6, control information for controlling the air vehicle 6 so that the air vehicle 6 communicates with the communication terminal 4. In a case where it is possible to maintain communication with the communication terminal 4a by emitting a radio wave having the maximum intensity that the LEO satellite 8 is able to emit, the control section 12 transmits control information for controlling the LEO satellite 8 so that the LEO satellite 8 increases the intensity of a radio wave to be emitted.

In a case where there is the air vehicle 6 that is not in communication with any of the plurality of communication terminals 4, the control section 12 may control the other end of communication of the communication terminal 4a so that the other end of communication is changed to the air vehicle 6, regardless of the intensity of a radio wave of the LEO satellite 8.

As above, in the communication system 100 in accordance with the present example embodiment, in a case where the condition of communication between the communication terminal 4a and the LEO satellite 8 worsens and the intensity of a radio wave attenuates, the server 2 controls the LEO satellite 8 so that the LEO satellite 8 increases a radio wave to be emitted. Thus, the server 2 is capable of suitably maintaining communication between the communication terminal 4a and the LEO satellite 8.

### Example Process 4 in Communication System 100

The acquiring section 11 of the server 2 may further acquire meteorological data (e.g., actually-measured meteorological data and weather forecasting data indicating a forecasted weather) at the location of the communication terminal 4a. As an example, the acquiring section 11 acquires actually-measured meteorological data and weather forecasting data from equipment which measures meteorological data and equipment which forecasts weather. In this case, the control section 12 further refers to the meteorological data acquired by the acquiring section 11, to control the air vehicle 6.

As an example, in a case where the intensity of a radio wave of the communication terminal 4 is smaller than a predetermined value based on the intensity of a radio wave indicated by the radio wave map, and the actually-measured meteorological data acquired indicates a decrease in the atmospheric pressure of the region in which the communication terminal 4 is located, the air vehicle 6 is controlled to measure an attenuation.

As another example, in a case where the intensity of a radio wave of the communication terminal 4 is smaller than a predetermined value based on the intensity of a radio wave indicated by the radio wave map, and the weather forecasting data acquired indicates that more clouds will cover the region in which the communication terminal 4 is located, the air vehicle 6 is controlled to measure an attenuation.

Thus, in a case where the weather of the region in which the communication terminal 4a is located is weather which could lead to worsening of a radio wave condition in the future, the control section 12 controls the air vehicle 6 so that the air vehicle 6 measures an attenuation.

As above, in the communication system 100 in accordance with the present example embodiment, the server 2 refers to actually-measured meteorological data and weather forecasting data of the region in which the communication terminal 4a is located, to control the air vehicle 6. This enables the server 2 to understand, in advance, that the radio wave condition of the communication terminal 4a will worsen in the future, and thus enables the communication terminal 4 to suitably maintain communication.

### Example Process 5 in Communication System 100

The server 2 may further refer to orbit information regarding the LEO satellite 8. As an example, the acquiring section 11 of the server 2 acquires orbit information regarding the LEO satellite 8, from the LEO satellite 8 (or, equipment which manages the LEO satellite 8). In this case, the control section 12 further refers to the orbit information acquired by the acquiring section 11, to control the air vehicle 6.

Since the LEO satellite 8 follows a predetermined orbit, the distance of the LEO satellite 8 to the communication terminal 4 is not constant. Thus, the radio wave condition of the communication terminal 4 varies depending on the position of the LEO satellite 8. Therefore, even in a case where, at the location of the communication terminal 4a, the intensity of a radio wave indicated by the information acquired from the communication terminal 4a is smaller than a predetermined value based on the intensity of a radio wave indicated by the radio wave map, when the control section 12 of the server 2 refers to the orbit information and determines that because the LEO satellite 8 is far away from the communication terminal 4a, the intensity of a radio wave indicated by the information acquired from the communication terminal 4a decreases, the control section 12 optionally does not control the air vehicle 6 so that the air vehicle 6 measures an attenuation.

In contrast, even in a case where, at the location of the communication terminal 4a, the intensity of a radio wave indicated by the information acquired from the communication terminal 4a is not smaller than a predetermined value based on the intensity of a radio wave indicated by the radio wave map, when the control section 12 determines that the intensity of a radio wave indicated by the information acquired from the communication terminal 4a decreases in spite of the LEO satellite 8 being located to be close to the communication terminal 4, the control section 12 may control the air vehicle 6 so that the air vehicle 6 measures an attenuation.

The LEO satellite 8 may change the intensity of a radio wave to be emitted, according to the distance of the LEO satellite 8 to the communication terminal 4. As an example, the LEO satellite 8 may change the intensity of a radio wave to be emitted, such that the intensity of a radio wave at the location of the communication terminal 4a is constant.

As above, in the communication system 100 in accordance with the present example embodiment, the server 2 refers to the orbit information regarding the LEO satellite 8, to control the air vehicle 6. Therefore, in a case where the intensity of a radio wave of the communication terminal 4 decreases due to the LEO satellite 8 being far away from the communication terminal 4, the server 2 does not control the air vehicle 6. This makes it possible to efficiently operate the air vehicle 6.

### Example Process 6 in Communication System 100

In addition to the server 2, the communication terminal 4 may store a radio wave map.

For example, the communication terminal 4 requests the server 2 to transmit a radio wave map. When accepting the request, the server 2 transmits, to the communication terminal 4, a radio wave map stored in the server storage section 25. The communication terminal 4 stores the radio wave map transmitted from the server 2, in storage section (not illustrated in FIG. 3) included in the communication terminal 4.

With this configuration, for example, in a case where the condition of communication with the LEO satellite 8 worsens, the communication terminal 4 transmits, to the server 2, information that contains an alert and that indicates the condition of communication with the LEO satellite 8. Examples of a case where the condition of communication with the LEO satellite 8 worsens encompass a case where the intensity of a radio wave is smaller than a predetermined value based on the intensity of a radio wave indicated by the radio wave map, a case where received power is smaller than a predetermined value, and a case where the error rate is higher than a predetermined value.

When receiving, from the communication terminal 4, information that contains an alert and that indicates the condition of communication with the LEO satellite 8, the control section 12 of the server 2 controls the air vehicle 6 so that the air vehicle 6 measures an attenuation.

As above, in the communication system 100 in accordance with the present example embodiment, the communication terminal 4 includes a radio wave map. It is thus possible for the communication terminal 4 to cause the server 2 to control the air vehicle 6 so that the air vehicle 6 measures an attenuation. Therefore, for example, in a case where the communication terminal 4 executes an application with the assurance of communication quality, it is possible to keep the communication quality of the communication terminal 4 by requesting, in advance, the server 2 to transmit a radio wave map. It is also possible for the communication terminal 4 to reduce the amount of processing of the server 2.

### Software Implementation Example

Some or all of the functions of each of the server 1, server 2, communication terminal 4, air vehicle 6, and LEO satellite 8 may be implemented by hardware such as an integrated circuit (IC chip), or may be implemented by software.

In the latter case, each of the server 1, server 2, communication terminal 4, air vehicle 6, and LEO satellite 8 is provided by, for example, a computer that executes instructions of a program that is software implementing the foregoing functions. An example (hereinafter, computer C) of such a computer is illustrated in FIG. 7. The computer C includes at least one processor C1 and at least one memory C2. The memory C2 has stored therein a program P for causing the computer C to operate as the server 1, the server 2, the communication terminal 4, the air vehicle 6, and the LEO satellite 8. The processor C1 of the computer C retrieves the program P from the memory C2 and executes the program P, so that the functions of each of the server 1, server 2, communication terminal 4, air vehicle 6, and LEO satellite 8 are implemented.

Examples of the processor C1 can encompass a central processing unit (CPU), a graphic processing unit (GPU), a digital signal processor (DSP), a micro processing unit (MPU), a floating point number processing unit (FPU), a physics processing unit (PPU), a microcontroller, and a combination thereof. Examples of the memory C2 can encompass a flash memory, a hard disk drive (HDD), a solid state drive (SSD), and a combination thereof.

The computer C may further include a random access memory (RAM) into which the program P is loaded when executed and in which various kinds of data are temporarily stored. The computer C may further include a communication interface via which data is transmitted to and received from another apparatus. The computer C may further include an input-output interface via which input-output equipment such as a keyboard, a mouse, a display or a printer is connected.

The program P can be recorded on a non-transitory, tangible recording medium M capable of being read by the computer C. Examples of such a recording medium M can encompass a tape, a disk, a card, a semiconductor memory, and a programmable logic circuit. The computer C can obtain the program P via such a recording medium M. Alternatively, the program P can be transmitted via a transmission medium. Examples of such a transmission medium can encompass a communication network and a broadcast wave. The computer C can obtain the program P also via such a transmission medium.

[Additional Remark 1]

The present invention is not limited to the foregoing example embodiments, but may be altered in various ways by a skilled person within the scope of the claims. For example, the present invention also encompasses, in its technical scope, any example embodiment derived by appropriately combining technical means disclosed in the foregoing example embodiments.

[Additional Remark 2]

The whole or part of the example embodiments disclosed above can be described as, but not limited to, the following supplementary notes.

(Supplementary Note 1)

A server including: an acquiring means for acquiring, from a communication terminal configured to communicate with low earth orbit satellite equipment, information which indicates a communication condition in the communication terminal regarding communication with the low earth orbit satellite equipment; and a controlling means for referring to a radio wave map of a region including a location of the communication terminal and the information, to control an air vehicle configured to measure an attenuation of a radio wave between the air vehicle and the communication terminal.

(Supplementary Note 2)

The server described in Supplementary note 1, in which in a case where, at the location of the communication terminal, an intensity of a radio wave indicated by the information is smaller than a predetermined value based on an intensity of a radio wave indicated by the radio wave map, the control means controls the air vehicle so that the air vehicle measures the attenuation at the location of the communication terminal.

(Supplementary Note 3)

The server described in Supplementary note 2, in which the air vehicle is further configured to communicate with the communication terminal, and the acquiring means further acquires the attenuation measured by the air vehicle, and in a case where the attenuation is greater than a predetermined value, the acquiring means controls the air vehicle so that the air vehicle communicates with the communication terminal.

(Supplementary Note 4)

The server described in Supplementary note 3, in which the control means further controls an emission direction of a radio wave emitted by the low earth orbit satellite equipment, and in a case where the attenuation is greater than a predetermined value, the control means controls the low earth orbit satellite equipment so that the low earth orbit satellite equipment changes the emission direction of the radio wave.

(Supplementary Note 5)

The server described in Supplementary note 2, in which the acquiring means further acquires the attenuation measured by the air vehicle, the control means further controls an intensity of a radio wave emitted by the low earth orbit satellite equipment, and in a case where the attenuation is greater than a predetermined value, the control means controls the low earth orbit satellite equipment so that the low earth orbit satellite equipment increases the intensity of the radio wave to be emitted.

(Supplementary Note 6)

The server described in any one of Supplementary notes 1 to 5, in which the acquiring means further acquires meteorological data at the location of the communication terminal, and the control means further refers to the meteorological data to control the air vehicle.

(Supplementary Note 7)

The server described in any one of supplementary notes 1 to 6, in which the acquiring means further acquires orbit information which indicates a predetermined orbit followed by the low earth orbit satellite equipment, and the control means further refers to the orbit information to control the air vehicle.

(Supplementary Note 8)

A control method including: a server acquiring, from a communication terminal configured to communicate with low earth orbit satellite equipment, information which indicates a communication condition in the communication terminal regarding communication with the low earth orbit satellite equipment; and the server referring to a radio wave map of a region including a location of the communication terminal and the information, to control an air vehicle configured to measure an attenuation of a radio wave between the air vehicle and the communication terminal.

(Supplementary Note 9)

A program for causing a computer to function as a server, the program causing the computer to function as: an acquiring means for acquiring, from a communication terminal configured to communicate with low earth orbit satellite equipment, information which indicates a communication condition in the communication terminal regarding communication with the low earth orbit satellite equipment; and a control means for referring to a radio wave map of a region including a location of the communication terminal and the information, to control an air vehicle configured to measure an attenuation of a radio wave between the air vehicle and the communication terminal.

(Supplementary Note 10)

A server including at least one processor, the at least one processor carrying out: an acquiring process of acquiring, from a communication terminal configured to communicate with low earth orbit satellite equipment, information which indicates a communication condition in the communication terminal regarding communication with the low earth orbit satellite equipment; and a controlling process of referring to a radio wave map of a region including a location of the communication terminal and the information, to control an air vehicle configured to measure an attenuation of a radio wave between the air vehicle and the communication terminal.

This server may further include a memory, and this memory may have stored therein a program for causing the at least one processor to carry out the acquiring process and the controlling process. In addition, this program may be recorded on a computer-readable, non-transitory, and tangible recording medium.

### REFERENCE SIGNS LIST

1, 2: Server
4: Communication terminal
6: Air vehicle
8: LEO satellite
11: Acquiring section
12: Control section
22: Satellite equipment control section
42: Terminal measuring section
43: Terminal outputting section
44: Terminal communication control section
62: Attenuation measuring section
63: Air vehicle outputting section
64: Air vehicle communication control section
84: Satellite communication control section
100: Communication system

1. A server comprising
at least one processor, the at least one processor carrying out:
an acquiring process of acquiring, from a communication terminal configured to communicate with low earth orbit satellite equipment, information which indicates a communication condition in the communication terminal regarding communication with the low earth orbit satellite equipment; and
a controlling process of referring to a radio wave map of a region including a location of the communication terminal and the information, to control an air vehicle configured to measure an attenuation of a radio wave between the air vehicle and the communication terminal.

2. The server according to claim 1, wherein
in a case where, at the location of the communication terminal, an intensity of a radio wave indicated by the information is smaller than a predetermined value based on an intensity of a radio wave indicated by the radio wave map, the at least one processor controls the air vehicle in the controlling process so that the air vehicle measures the attenuation at the location of the communication terminal.

3. The server according to claim 2, wherein
the air vehicle is further configured to communicate with the communication terminal, and
the at least one processor
further acquires, in the acquiring process, the attenuation measured by the air vehicle, and
in a case where the attenuation is greater than a predetermined value, controls the air vehicle in the controlling process so that the air vehicle communicates with the communication terminal.

4. The server according to claim 3, wherein
the at least one processor
further controls, in the controlling process, an emission direction of a radio wave emitted by the low earth orbit satellite equipment, and
in a case where the attenuation is greater than a predetermined value, controls the low earth orbit satellite equipment in the controlling process so that the low earth orbit satellite equipment changes the emission direction of the radio wave.

5. The server according to claim 2, wherein
the at least one processor
further acquires, in the acquiring process, the attenuation measured by the air vehicle,
further controls, in the controlling process, an intensity of a radio wave emitted by the low earth orbit satellite equipment, and
in a case where the attenuation is greater than a predetermined value, controls the low earth orbit satellite equipment in the controlling process so that the low earth orbit satellite equipment increases the intensity of the radio wave to be emitted.

6. The server according to claim 1, wherein
the at least one processor
further acquires meteorological data at the location of the communication terminal, in the acquiring process, and
further refers to the meteorological data to control the air vehicle, in the controlling process.

7. The server according to claim 1, wherein
the at least one processor
further acquires orbit information which indicates a predetermined orbit followed by the low earth orbit satellite equipment, in the acquiring process, and
further refers to the orbit information to control the air vehicle, in the controlling process.

8. A control method comprising:
at least one processor included in a server acquiring, from a communication terminal configured to communicate with low earth orbit satellite equipment, information which indicates a communication condition in the communication terminal regarding communication with the low earth orbit satellite equipment; and
the at least one processor referring to a radio wave map of a region including a location of the communication terminal and the information, to control an air vehicle configured to measure an attenuation of a radio wave between the air vehicle and the communication terminal.

9. The control method according to claim 8, wherein
in a case where, at the location of the communication terminal, an intensity of a radio wave indicated by the information is smaller than a predetermined value based on an intensity of a radio wave indicated by the radio wave map, the at least one processor controls the air vehicle in the referring so that the air vehicle measures the attenuation at the location of the communication terminal.

10. The control method according to claim 9, wherein
the air vehicle further communicates with the communication terminal, and
the at least one processor
further acquires, in the acquiring, the attenuation measured by the air vehicle, and
in a case where the attenuation is greater than a predetermined value, controls the air vehicle in the referring so that the air vehicle communicates with the communication terminal.

11. The control method according to claim 10, wherein
the at least one processor
further controls, in the referring, an emission direction of a radio wave emitted by the low earth orbit satellite equipment, and
in a case where the attenuation is greater than a predetermined value, controls the low earth orbit satellite equipment in the referring so that the low earth orbit satellite equipment changes the emission direction of the radio wave.

12. The control method according to claim 9, wherein
the at least one processor
further acquires, in the acquiring, the attenuation measured by the air vehicle,
further controls, in the referring, an intensity of a radio wave emitted by the low earth orbit satellite equipment, and
in a case where the attenuation is greater than a predetermined value, controls the low earth orbit satellite equipment in the referring so that the low earth orbit satellite equipment increases the intensity of the radio wave to be emitted.

13. The control method according to claim 8, wherein
the at least one processor
further acquires meteorological data at the location of the communication terminal, in the acquiring, and
further refers to the meteorological data to control the air vehicle, in the referring.

14. The control method according to claim 8, wherein
the at least one processor
further acquires orbit information which indicates a predetermined orbit followed by the low earth orbit satellite equipment, in the acquiring, and
further refers to the orbit information to control the air vehicle, in the referring.

15. A computer-readable non-transitory recording medium having recorded thereon a program for causing a computer to function as a server,
the program causing the computer to carry out:
an acquiring process of acquiring, from a communication terminal configured to communicate with low earth orbit satellite equipment, information which indicates a communication condition in the communication terminal regarding communication with the low earth orbit satellite equipment; and
a controlling process of referring to a radio wave map of a region including a location of the communication terminal and the information, to control an air vehicle configured to measure an attenuation of a radio wave between the air vehicle and the communication terminal.

16. The computer-readable non-transitory recording medium according to claim 15, wherein
in a case where, at the location of the communication terminal, an intensity of a radio wave indicated by the information is smaller than a predetermined value based on an intensity of a radio wave indicated by the radio wave map, the program causes the computer to control the air vehicle in the controlling process so that the air vehicle measures the attenuation at the location of the communication terminal.

17. The computer-readable non-transitory recording medium according to claim 16, wherein
the air vehicle further communicates with the communication terminal, and
the program causes the computer to
further acquire, in the acquiring process, the attenuation measured by the air vehicle, and
in a case where the attenuation is greater than a predetermined value, control the air vehicle in the controlling process so that the air vehicle communicates with the communication terminal.

18. The computer-readable non-transitory recording medium according to claim 17, wherein
the program causes the computer to
further control, in the controlling process, an emission direction of a radio wave emitted by the low earth orbit satellite equipment, and
in a case where the attenuation is greater than a predetermined value, control the low earth orbit satellite equipment in the controlling process so that the low earth orbit satellite equipment changes the emission direction of the radio wave.

19. The computer-readable non-transitory recording medium according to claim 16, wherein
the program causes the computer to
further acquire, in the acquiring process, the attenuation measured by the air vehicle,
further control, in the controlling process, an intensity of a radio wave emitted by the low earth orbit satellite equipment, and
in a case where the attenuation is greater than a predetermined value, control the low earth orbit satellite equipment in the controlling process so that the low earth orbit satellite equipment increases the intensity of the radio wave to be emitted.

20. The computer-readable non-transitory recording medium according to claim 15, wherein
the program causes the computer to
further acquire orbit information which indicates a predetermined orbit followed by the low earth orbit satellite equipment, in the acquiring process, and
further refer to the orbit information to control the air vehicle, in the controlling process.
